(19) United States
(12) Patent Application Publication
(10) Pub. No.: US 2005/0230605 A1
(43) Pub. Date: Oct. 20, 2005

(54) Method of measuring using a binary optical sensor

(76) Inventor: Hamid Pishdadian, Warwick, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/104,712

(22) Filed: Apr. 13, 2005

Related U.S. Application Data
(60) Provisional application No. 60/563,620, filed on Apr. 20, 2004.

(51) Int. Cl. H01J 40/14

(52) U.S. Cl. 250/221

(57) ABSTRACT

A method of measuring distance includes the steps of providing an optical device with an optical emitter and an optical sensor that are aligned with one another. An interrupter pin is movably positioned between the optical emitter and the optical sensor. When the interrupter pin is positioned between the optical emitter and the optical sensor, an amount of optical radiation passes from the optical emitter to the optical sensor. The amount of optical radiation that passes from the optical emitter to the optical sensor correlates to the position of the interrupter pin therebetween and the amount of optical radiation that the interrupter pin permits to pass from the optical emitter to the optical sensor. The amount of optical radiation is senses by the optical sensor. The amount of radiation sensed by the radiation sensor is correlated to the position of the interrupter pin. The interrupter pin is connected to an object, the position of which is to be measured. Movement of the object causes movement of the interrupter pin between the optical emitter and the optical sensor to result in detection of an amount of optical radiation that correlates with the position of the object to be measured.

### CROSS-REFERENCE TO RELATED APPLICATIONS

This application claims priority from prior U.S. Provisional Application Ser. No. 60/563,620 filed on Apr. 20, 2004.

### BACKGROUND OF THE INVENTION

The present invention generally relates to method of measuring. More specifically, the present invention relates to a new and novel method and device for measuring physical properties, such as distance, pressure and volume.

In the prior art, devices for measuring physical properties, such as distance, are very well known in the prior art. Strain gauges, capacitor plates, resistive arrangements and lasers have been used to measure physical properties, such as distance.

Typical mechanical measuring devices are gauges and calipers which commonly include some type armature that communicates with the object to be measured. In an example of measurement of distance, the armature is connected to the object to measured so that when the object moves, the armature moves proximal to a plate with measurement indicia thereon. Thus, movement of the object causes the armature to be aligned with the indicia which indicates the amount of travel of the object itself. These mechanical gauges have limited value because they are typically very expensive, particularly those that are very accurate.

Electronic measuring devices are also well known in art for purposes of measuring physical properties. For example, lasers are commonly used for measuring because of their accuracy. In one well known example, an armature can be provided with an array of indicia thereon. A laser is directed to the armature and reflected back to a sensor. The amount and nature of the sensed reflected signal is processed to determine the physical property of the object to be measured. For example, an armature can be digitally encoded. As it passed in front of a laser, a digital signal is reflected back and processed to determine the position of the armature. As a result, such as laser arrangement can be used to measure distance and other physical properties.

While measurement devices and methods of the prior art are typically accurate, their primary disadvantage is high cost making them unsuitable for many applications.

Thus, there is a need for a method of measuring physical properties and a apparatus therefor that is very accurate yet inexpensive to manufacture and assemble.

There is a need for a method of measuring that can be easily adapted for the measurement of a wide range of physical properties, such as distance, pressure and volume.

There is a further need for a method of measuring that uses an apparatus that is easy to assemble and operate.

### SUMMARY OF THE INVENTION

The present invention preserves the advantages of prior art methods and devices for measuring distance. In addition, it provides new advantages not found in currently available methods and devices and overcomes many disadvantages of such currently available methods and devices.

The invention is generally directed to a novel and unique method for measuring distance using a digital radiation sensor, such as an optical photomicrosensor.

The method of measuring distance of the present invention includes the steps of providing an optical emitter and an optical sensor that are aligned with one another. An interrupter pin is movably positioned between the optical emitter and the optical sensor. When the interrupter pin is positioned between the optical emitter and the optical sensor, an amount of optical radiation passes from the optical emitter to the optical sensor. The amount of optical radiation that passes from the optical emitter to the optical sensor correlates to the position of the interrupter pin therebetween and the amount of optical radiation that the interrupter pin permits to pass from the optical emitter to the optical sensor. The amount of optical radiation is senses by the optical sensor. The amount of radiation sensed by the radiation sensor is correlated to the position of the interrupter pin.

The interrupter pin is connected to an object, the position of which is to be measured. Movement of the object causes movement of the interrupter pin between the optical emitter and the optical sensor to result in detection of an amount of optical radiation that correlates with the position of the object to be measured. For example, the object may be a diaphragm whereby distance of travel of the diaphragm corresponds to amount of pressure placed on the diaphragm. Therefore, the amount of optical radiation sensed by the optical sensor correlates directly to pressure on the diaphragm. As a result, pressure can be sensed by using the method of measuring distance of the present invention.

It is therefore an object of the present invention to provide a method of measuring that is accurate.

It is an object of the present invention to provide a method of measuring that uses parts and components are very inexpensive.

It is a further object of the present invention to provide a method of measuring that can be used to measure a wide range of physical properties including distance, pressure and volume.

Another object of the present invention is to provide a measuring apparatus that is inexpensive yet very accurate.

It is a further object of the present invention to provide a measuring apparatus that can be used to measure a wide range of physical properties including distance, pressure and volume.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a perspective view of a binary optical sensor used to employ the method of measuring of the present invention;

FIG. 2 is a side view of the binary optical sensor of FIG. 1 using in the environment of a pressure sensor to measure pressure;

FIG. 3 is a graphical representation of light current generated against travel distance of the interrupter pin;

FIG. 4 is a side elevational view of a first alternative embodiment of an interrupter pin having an angled leading edge used in accordance with the present invention; and

FIG. 5 is a side elevational view of a second alternative embodiment of an interrupter pin having a rounded leading edge used in accordance with the present invention.

### DETAILED DESCRIPTION OF THE PREFERRED EMBODIMENT

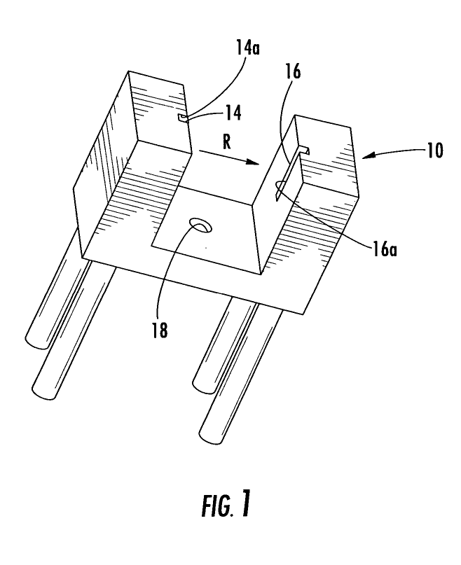

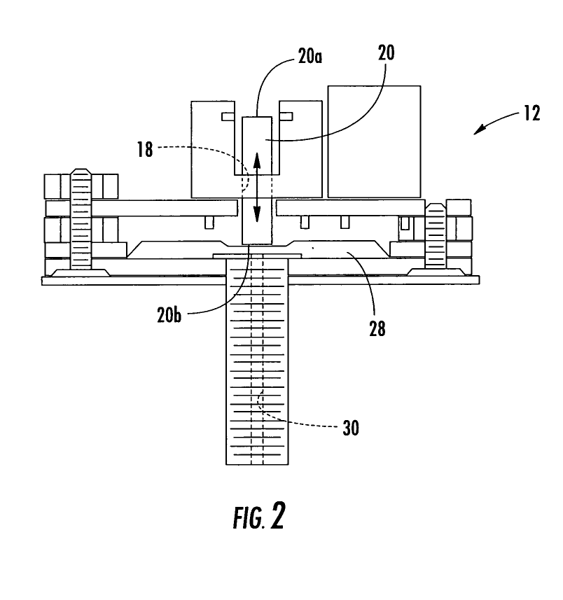

Referring first to FIG. 1, a perspective view of a binary optical device 10, which is used to carry out the method of the present invention, is shown. FIG. 2 illustrates use of the binary optical device in an environment of a pressure sensor 12 for purposes of sensing pressure using the method of the present invention. The optical device 10 of the present invention is shown in FIGS. 1 and 2 in the environment of an apparatus 12 for sensing pressure using a diaphragm 14. It should be understood that the method of measuring of the present invention and the associated apparatus sensor 10 can be used to measure a wide range of physical properties including distance, pressure and volume. More specifically, the method of the present invention is employed to measure distance which, in turn can be used to measure other physical properties, such as pressure and volume. For ease of illustration and explanation, the method and device 10 of the present invention is shown in a pressure sensing apparatus 12. The present invention is not in any way limited to measuring pressure.

Still referring to FIGS. 1 and 2, the method of measuring of the present invention uses a binary type optical sensing arrangement in the form of an optical device 10 as can best be seen in FIG. 1. For example, the binary switch 10 used for carrying out the method of the present invention can be a binary sensor with Model number EE-SX1082 and made by the Omron Company.

The binary optical switch device 10 includes a optical emitter 14 and an optical sensor receiver 16. The optical emitter 14 emits radiation, such as light in the visible, infrared or ultraviolet spectrum in the direction indicated by the arrow R. The optical sensor 16 is positioned proximal to the optical emitter 14 and aligned therewith. The optical emitter 14 includes a window 14a, having a width, through which the optical radiation is emitted. Thus, the radiation is in the form of a beam having a given width. The optical sensor 16 similarly has field of view window 16a that has a width for receiving the emitted optical radiation beam, as generally represented by arrow R. A through aperture 18 is provided to slidably receive an interrupter pin, as will be described below.

As seen in FIG. 2, an interrupter pin 20 movably actuates within aperture 18 and in and out from between the optical emitter 14 and the optical sensor 16. The interrupter pin 20 serves to block or partially block the transmission of optical radiation R from the optical emitter 14 to the optical sensor 16.

In the prior art, the switch 10 is used in a binary or digital fashion where it is used in either an ON or OFF condition. For example, when an interrupter pin 20 is completely blocking the path of the optical radiation R, the optical sensor 16 will not sense the radiation thereby corresponding to an OFF condition. Similarly if the interrupter pin 20 is not blocking the path of the optical radiation R at all, the optical sensor 16 will sense the optical radiation R thereby corresponding to an ON condition. As is well known in the art, circuit design can generate an ON condition when the pin 20 is blocking the light path and an OFF condition when it is not blocking the light path.

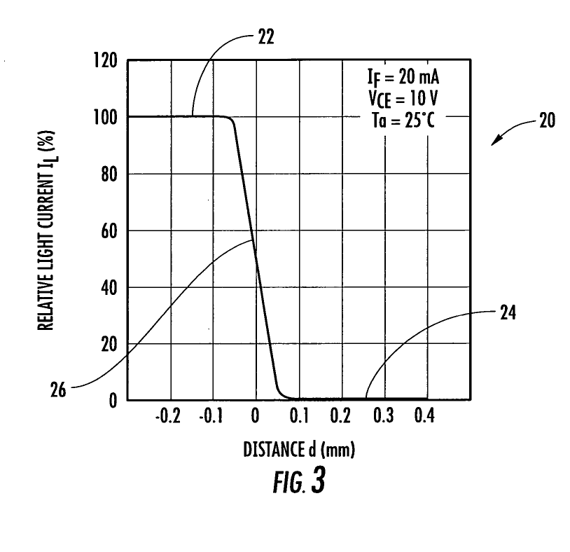

Turning now to FIG. 3, a graph 20 of the relative light current generated by the optical sensor 16 as a result of receiving optical radiation R from the optical emitter 14 is shown. As can be seen, the current generated moves from a HIGH condition, at 22, to a LOW condition, at 24, with a transition region 26 therebetween. This illustrates the movement of interrupter pin 20 from a fully blocking position to a fully open condition or vice versa. As seen in the graph 20 of FIG. 3, the amount of current generated by the optical sensor 16 corresponding to the light sensed can be quantified at all times over the travel of the interrupter pin 20. The distance of travel of the interrupter pin 20 through transition region 26 permits a corresponding amount of light through to the optical sensor 16 which is monitored in accordance with the present invention. However, in known prior art applications of this binary switch 10, only the HIGH and LOW conditions are of interest which correspond respectively to 100% light being sensed or 0% light being sensed.

For example, in the prior art, the switch 10 is used in a binary fashion to sense whether a door is open on a photocopy machine (not shown). In this prior art use of the switch 10, a interrupter pin 20 is connected to a door so that when the door is closed, the pin blocks transmission of the optical radiation from the optical emitter to the optical sensor thereby indicating that the door is properly closed. When the door is open, the light beam is not broken indicating to the operating system of the photocopy machine that the door is open and the operation of the photocopy machine should be halted until the door is closed. Thus, in this example, the binary optical switch 10 only operates “ON” or “OFF”.

The method of the present invention uses the optical switch of FIGS. 1 and 2 and the characteristics of FIG. 3 to measure distance by tracking the changing amount of radiation R sensed by the optical sensor 16 when the interrupter pin 20 is present in the transition region 26 of the operation of the switch 10. This use of a binary optical switch 10 in an analog fashion in the transition region 26 is completely new and novel in the art. When the interrupter pin 20 travels through the transition region 26, partial detection of optical radiation occurs because the beam R from the optical emitter 14 is being partially blocked by the interrupter pin 20 in this transition region 26. This transition region 26 is over a distance that is substantially equal to the width of the beam of optical radiation, as defined by windows 14a and 16a, traveling from the optical emitter 14 to the optical sensor 16. It can therefore be understood that different positions of the interrupter pin 20 within the transition region 26 will block different amounts of radiation or light R thereby permitting different amounts of light R to reach the optical sensor 16 thereby generating different amounts of relative light current at the optical sensor 16.

Thus, it has been found that the amount of light sensed (due to partial interruption of light by the pin 20) correlates to the distance the pin 20 travels. Referring back to FIG. 3, it can be seen that the transition region 26 in this example switch is approximately 0.2 mm of travel of the interrupter pin 20 even though the overall width of the sensing aperture can be as great as 3 mm, in this example. Over the course of this travel in the transition region 26, the light sensed gradually changes from 0 to 100 percent. The positioning of the interrupter pin 20 within the transition region 26 blocks an amount of light R that corresponds to a current flow from the optical sensor 16. The position of the interrupter pin 20 in the transition region 26 also corresponds with overall location of the interrupter pin 20 to indicate distance travel. Appropriate software can be used, after calibration, to generate a desired measurement output result in the required units.

An example of use of the device 10 to carry out the method for measuring for the purposes of measuring pressure is shown in FIG. 2. The distance of travel of a structure can be measured using the method of the present invention. One such structure, the movement of which, can be accurately measured using the method of the present invention is a pressure diaphragm 28. An interrupter pin 20, such as one with a flat leading edge 20a, travels in the transition region 26 of the binary switch 10 of FIGS. 1-3 where the interrupter pin 20 communicates with the pressure diaphragm 28. For example, the lower end 20b of interrupter pin 20 is preferably permanently secured to the diaphragm 28 by soldering, welding, adhesive and the like. In this example, air is introduced against a flexible diaphragm 28 via conduit 30, as seen in FIG. 2, from a source of air the pressure of which is to be measured. The air through conduit 30 deflects the diaphragm a distance due to the air pressure against it via the conduit 30. As the diaphragm 28 is deflected upwards due to the impact of pressure, the interrupter pin 20 moves accordingly a given distance. Thus, in this example, the pin 20 is used to measure the amount of deflection of the diaphragm 28 in a pressure sensor 12. The amount of diaphragm deflection can then be correlated to pressure against the diaphragm 28 knowing the pressure environment and the type of diaphragm 28 used. Correlation of diaphragm deflection and the amount of pressure is well known in the art and need not be discussed in detail herein. The method of the present invention is a viable and extremely accurate alternative to prior art pressure sensors.

Below is a table showing, as an example of the operation of the device 10 of FIGS. 1-3 and using the method of the present invention to measure pressure. This is an example of one of the many different physical properties than can be measured using the method and device of the present invention.

TABLE 1

| Pin | Percent of | Output of | Corresponding |
|---|---|---|---|
| Position | Light | Optical | Pressure |
| (inch) | Sensed (%) | Sensor (V) | (psi) |
| 0 | 0 | 1 | 0 |
| 0.0025 | 25 | 1.75 | 25 |
| 0.005 | 50 | 2.5 | 50 |
| 0.0075 | 75 | 3.25 | 75 |
| 0.01 | 100 | 4.0 | 100 |

As can be understood, the optical device 10 with the actuating interrupter pin 20 arrangement may be used for measuring physical properties in many other applications. As a further example, the unique method of the present invention can be used to measure distance directly. The interrupter pin 20 may be connected directly to an armature (not shown) for measuring the length of a structure. The method of measuring can also be used for precise weight measurement where the interrupter pin 20 of the optical device is connected to a spring-biased platen (now shown). As the spring compresses, the pin 20 moves within the transition region 26 of operation of the optical device 10. The distance of travel of the pin 20 can then be calibrated and thereby correlated to the weight on the platen that effectuates compression of the spring so that the method can serve as a scale. Also, the method can be used to measure angular position and velocity using graduated, ramped disk, for example. Further, the method and device can be used to measure flow rate through a pipe using displacement of a member within the pipe body.

Essentially, if the same optical device 10 is used, the data is Table 1 will be identical with the exception of the far right column which would be translated to weight sensed after the appropriate calibration and translation of data to the weight units. In view of the foregoing, the method and device 10 of the present invention can be easily adapted to measure any type of physical property in any environment.

Adaptation of the method and device 10 of the present invention may require modification thereof to better accommodate the application at hand. The interrupter pin 20 of the preferred embodiment of FIGS. 1-3 has a flat leading edge 20a that is substantially perpendicular to the actuation path, as represented by the arrow of FIG. 2, of the interrupter pin 20. As seen in Table 1 above, this results in a substantially linear correlation of the distance traveled by the interrupter pin 20 with the current output of the optical sensor 16. However, this may not be suitable in certain environments and for measurement of certain physical properties.

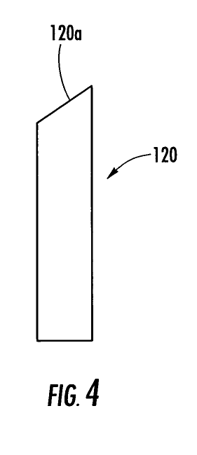

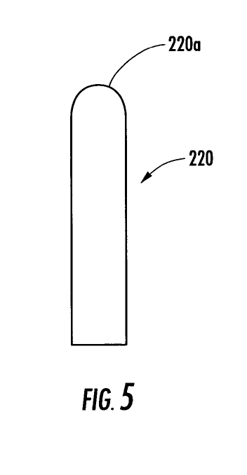

As shown in FIGS. 4 and 5, alternative embodiments 120 and 220 of the interrupter pin 20 is shown. The respective leading edges 120a and 220a of pins 120 and 220 may be other configurations, such as round or ellipsoid in cross-section. In FIG. 4, the leading edge 120a is angled while the leading edge 220a in FIG. 5 is rounded. Further, the leading edge of the interrupter pin 20, 120, 220 can be profiled to, in turn, control the profile of the transition area of the optical device switch 10. For example, this profiling of the leading edge of the pin 20, 120, 220 can make the transition area 26 of FIG. 3 of the switching non-linear. This can be tuned to make the transition area 26 wider and, thus, more accurate. However, in some applications, in may be desirable to make the transition area 26 linear. As can be understood, the profile of the leading edges 20a, 120a and 220a of the respective interrupter pins 20, 120 and 220 and their transition areas is selected according to the structure to be interfaced with and the physical property to be measured.

In view of the foregoing, the present invention provides a unique method of measuring using the transition region 26 of operation of a binary switching device 10. Actuation of an interrupter pin 20 in this transition region 26, namely the travel therethrough, measures the distance of travel of another object or structure attached thereto. The amount of light sensed corresponds to the amount of travel of the pin 20 and, therefore, the distance measured which can be correlated to any other physical property for accurate measurement thereof.

It should be understood that the switching device 10 discussed herein is just one example of the many different types of switching devices 10 that can be used to carry out the method of the present invention. The binary switch 10 shown in FIGS. 1-3 is ideal because it is very inexpensive yet can be used to measure distance, and in turn pressure and the like, with very high accuracy. Other binary optical switches of different configurations can be employed in carrying out the method of the present invention.

In summary, a new and novel method is provided that operates inexpensive optical devices in the transition region 26 for the purposes of measurement of interrupter pin 20 travel and associated physical property measurement rather than for binary switching purposes. To achieve high accuracy measurement in prior art devices, expensive lasers and other components much be used. In contrast, the method of measuring of the present invention is far superior to prior art methods and devices because it is very inexpensive without sacrificing measurement accuracy.

It would be appreciated by those skilled in the art that various changes and modifications can be made to the illustrated embodiments without departing from the spirit of the present invention. All such modifications and changes are intended to be covered by the appended claims.

1. A method of measuring distance, comprising the steps of:
providing a radiation emitter;
providing a radiation sensor; the radiation emitter being aligned with the radiation sensor;
providing an interrupter pin;
positioning the interrupter pin between the radiation emitter and the radiation sensor;
permitting an amount of radiation from the radiation emitter to reach the radiation sensor depending on the position of the interrupter pin therebetween;
determining the amount of radiation sensed by the radiation sensor;
correlating the amount of radiation sensed by the radiation sensor with the position of the interrupter pin between the radiation emitter and the radiation sensor; and
calculating the position of the interrupter pin from the amount of radiation sensed by the radiation sensor.

2. The method of claim 1, further comprising the steps of;
connecting the interrupter pin to an object; and
calculating the position of the object by determining the position of the interrupter pin.

3. The method of claim 1, wherein the radiation emitter is an optical emitter.

4. The method of claim 1, wherein the radiation sensor is an optical sensor.

5. The method of claim 1, wherein the radiation is infrared light.

6. The method of claim 1, wherein the radiation is visible light.

7. The method of claim 2, wherein the object is a diaphragm whereby distance of travel of the diaphragm corresponds to amount of pressure placed on the diaphragm.

8. A method of measuring distance, comprising the steps of:
providing an optical emitter having an output window with a top edge and a bottom edge;
providing a optical sensor having an input window with a top edge and a bottom edge; the output window of the optical emitter being aligned with the input window of the optical sensor defining a transition window;
providing an interrupter pin, having a edge; the interrupter pin being movable through the transition window thereby blocking passage of an amount of optical radiation from the optical emitter to the optical sensor depending on the position of the edge of the interrupter pin in the transition window and the position of the interrupter pin itself;
locating the edge of the interrupter pin within the transition window;
determining the amount of optical radiation sensed by the optical sensor;
correlating the amount of optical radiation sensed by the optical sensor with the position of the edge of the interrupter pin in the transition window; and
determining the position of the interrupter pin from the position of its edge.

9. The method of claim 8, further comprising the steps of;
connecting the interrupter pin to an object; and
calculating the position of the object by determining the position of the edge of the interrupter pin.

10. The method of claim 8, wherein the optical radiation is infrared light.

11. The method of claim 8, wherein the optical radiation is visible light.

12. The method of claim 9, wherein the object is a diaphragm whereby distance of travel of the diaphragm corresponds to amount of pressure placed on the diaphragm.

13. The method of claim 8, wherein the edge of the interrupter pin is flat.

14. The method of claim 8, wherein the edge of the interrupter pin is angled.

15. The method of claim 8, wherein the edge of the interrupter pin is rounded.

16. An apparatus for measuring pressure, comprising:
an optical emitter;
an optical sensor; the optical emitter being aligned with the optical sensor;
an interrupter pin movably positioned between the optical emitter and the optical sensor; the position of the interrupter pin permitting an amount of optical radiation from the optical emitter to reach the optical sensor; the amount of optical radiation sensed by the optical sensor correlating to the position of the interrupter pin between the optical emitter and the optical sensor.

17. The apparatus of claim 16, further comprising;
an object, the positioned of which to be measured, connected to the interrupter pin.

18. The apparatus of claim 17, wherein the object is a diaphragm whereby distance of travel of the diaphragm corresponds to amount of pressure placed on the diaphragm.
